(19) United States
(12) Patent Application Publication
(10) Pub. No.: US 2015/0371605 A1
(43) Pub. Date: Dec. 24, 2015

(54) Pixel Mapping and Rendering Methods for Displays with White Subpixels

(71) Applicant: Apple Inc., Cupertino, CA (US)

(72) Inventors: Jiaying Wu, Santa Clara, CA (US); Jun Jiang, Campbell, CA (US); Gabriel Marcu, San Jose, CA (US); Cheng Chen, San Jose, CA (US)

(21) Appl. No.: 14/311,598

(22) Filed: Jun. 23, 2014

(51) Int. Cl. G09G 5/02; G09G 5/18; G09G 5/10

(52) U.S. Cl. CPC G09G 5/02; G09G 5/10; G09G 5/18; G09G 2360/144

(57) ABSTRACT

An electronic device may include a display having an array of display pixels. The display pixels may include red, green, blue, and white subpixels. Pixel mapping circuitry may convert red-green-blue pixel values in a frame of display data to red-green-blue-white pixel values using a brightness adjustment factor. The brightness adjustment factor may be determined based on ambient lighting conditions. The brightness adjustment factor be determined such that any color distortion resulting from applying the brightness adjustment factor is maintained under a just-noticeable-difference (JND) threshold. White subpixel values may be determined based on the brightness adjustment factor. Pixel rendering circuitry may be used to render red-green-blue-white pixel values onto the physical pixel structure. When a display pixel does not include a subpixel of a particular color, the pixel rendering circuitry may compensate for the missing color using nearby subpixels.

### BACKGROUND

This relates generally to electronic devices with displays and, more particularly, to electronic devices with displays having white subpixels.

Electronic devices often include displays. For example, an electronic device may have a liquid crystal display or an organic light-emitting diode display with rows and columns of display pixels. The display pixels may each have subpixels with respective red, blue, and green color filter elements. There can be non-negligible amounts of optical absorption in the color filter material of red, blue, and green subpixels, so some designs incorporate white subpixels. Pixel mapping operations may covert red-green-blue (RGB) data to red-green-blue-white (RGBW) data to ensure that the white subpixels are frequently used. This helps reduce power consumption because the white subpixels are more efficient at emitting light than the colored subpixels.

In conventional mapping methods, a standard mapping formula is applied to RGB input pixel values to obtain RGBW output pixel values. For example, some RGBW display systems employ a mapping formula that ensures pixels do not experience clipping upon conversion from RGB to RGBW. However, this method can lead to brightness gain imbalances since neutral colors will typically undergo a higher brightness gain than chromatic colors. The result is sometimes referred to as a simultaneous contrast problem.

To avoid brightness gain imbalances, some RGBW display systems employ a different standard mapping formula whereby a global gain is applied to all pixels, which results in some pixel clipping but avoids the simultaneous contrast issue. This method, however, is not optimal for all types of image scenarios. For example, pixel clipping may be noticeable to the human eye for certain types of images such as website images and user interface content.

Pixel rendering operations are used to render RGBW pixel signals onto the physical structure of the pixel. In conventional pixel rendering operations, the red, green, blue, and white pixel values are rendered directly on corresponding red, green, blue, and white subpixels.

However, some pixel structures in a display may not include a blue subpixel or a white subpixel, and the direct rendering approach can lead to artifacts such as missing parts of a blue line.

It would therefore be desirable to be able to provide improved ways of displaying images on displays such as displays with white subpixels.

### SUMMARY

An electronic device may include a display having an array of display pixels. The display pixels may include red, green, blue, and white subpixels.

Pixel mapping circuitry may convert red-green-blue pixel values in a frame of display data to red-green-blue-white pixel values using a brightness adjustment factor. The brightness adjustment factor may be determined based on ambient lighting conditions. A backlight in the display may be adjusted based on the brightness adjustment factor and the ambient lighting conditions. For example, the backlight may be operated in a low power mode when the display is in indoor ambient lighting conditions, while the overall display brightness is maintained using the brightness adjustment factor.

The brightness adjustment factor be determined such that any color distortion resulting from applying the brightness adjustment factor is maintained under a just-noticeable-difference (JND) threshold.

White subpixel values may be determined based on the brightness adjustment factor such that white luminance is evenly distributed to the red, green, blue, and white subpixels, which in turn helps to avoid the appearance of black “holes” in pixels where not enough luminance is contributed by a white subpixel or by red, green, and blue subpixels.

Pixel rendering circuitry may be used to render red-green-blue-white pixel values onto the physical pixel structure. When a display pixel does not include a subpixel of a particular color, the pixel rendering circuitry may compensate for the missing color using nearby subpixels. This may include, for example, receiving a first subpixel value for a first subpixel at a first location on the display and determining a second subpixel value for a second subpixel at a second location on the display based at least partly on the first subpixel value. For example, the second subpixel may be a blue subpixel that is turned on to compensate for a missing blue sub-pixel in a neighboring red-green-white display pixel (e.g., in displays that include a RGB-RGW pixel structure).

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a portable computer having a display in accordance with an embodiment of the present invention.

FIG. 2 is a perspective view of an illustrative electronic device such as a cellular telephone or other handheld device having a display in accordance with an embodiment of the present invention.

FIG. 3 is a perspective view of an illustrative electronic device such as a tablet computer having a display in accordance with an embodiment of the present invention.

FIG. 4 is a perspective view of an illustrative electronic device such as a computer monitor with a built-in computer having a display in accordance with an embodiment of the present invention.

FIG. 5 is a schematic diagram of an illustrative electronic device having a display in accordance with an embodiment of the present invention.

FIG. 6 is a diagram of a portion of an illustrative display showing how red, green, blue, and white subpixels may be arranged in rows and columns in accordance with an embodiment of the present invention.

FIG. 7 is a diagram of illustrative circuitry that may be used to display images on a display having white subpixels in accordance with an embodiment of the present invention.

FIG. 8 is a diagram of a conventional approach to mapping red-green-blue pixel values to red-green-blue-white pixel values.

FIG. 9 is a flow chart of illustrative steps involved in displaying images on a display using pixel mapping circuitry and pixel rendering circuitry in accordance with an embodiment of the present invention.

FIG. 10 is a flow chart of illustrative steps involved in determining a brightness adjustment factor using an iterative method in accordance with an embodiment of the present invention.

FIG. 11 is a flow chart of illustrative steps involved in determining a brightness adjustment factor using an interpolation method in accordance with an embodiment of the present invention.

### DETAILED DESCRIPTION

Electronic devices such as cellular telephones, media players, computers, set-top boxes, wireless access points, and other electronic equipment may include displays.

Displays may be used to present visual information and status data and/or may be used to gather user input data.

Displays such as liquid crystal displays and organic light-emitting diode (OLED) displays may include an array of display pixels. Each display pixel may include one or more colored subpixels for displaying color images. For example, a display pixel such as a red-green-blue-white (RGBW) display pixel may include a red subpixel, a green subpixel, a blue subpixel, and a white subpixel. During display operations, the RGBW pixel may receive a red subpixel value, a green subpixel value, a blue subpixel value, and a white subpixel value that together define the color to be created by that pixel. These red, green, blue, and white values are sometimes referred to herein in the aggregate as “RGBW values,” as understood to those of ordinary skill in the art.

In some types of displays, colored subpixels such as red, green, and blue subpixels are formed by filtering white light with color filter elements (e.g., red, green, and blue color filter elements). White subpixels may be formed using unfiltered white light.

Because white subpixels are unfiltered, white subpixels tend to be more power efficient than red, green, and blue subpixels. It may therefore be beneficial to use the white subpixel to produce a portion of the luminance in a given color. For example, a color may be defined by a given set of RGB values and an RGB luminance. That same color can be produced using an associated set of RGBW values by allocating a portion of the RGB luminance to the white subpixel.

Electronic devices may include display control circuitry for controlling operation of the display. The display control circuitry may include pixel mapping circuitry for converting incoming frames of display data from an RGB color space to the RGBW color space. For example, the pixel mapping circuitry may convert input red, green, and blue pixel values (sometimes referred to herein in the aggregate as input RGB pixel values) to red, green, blue, and white (RGBW) pixel values. The display control circuitry may also include pixel rendering circuitry for rendering the RGBW pixel values onto the physical structure of each display pixel. For example, pixel rendering circuitry may determine how to render RGBW pixel values onto display pixels that include red-green-blue pixels and red-green-white pixels (sometimes referred to as an RGB-RGW pixel structure).

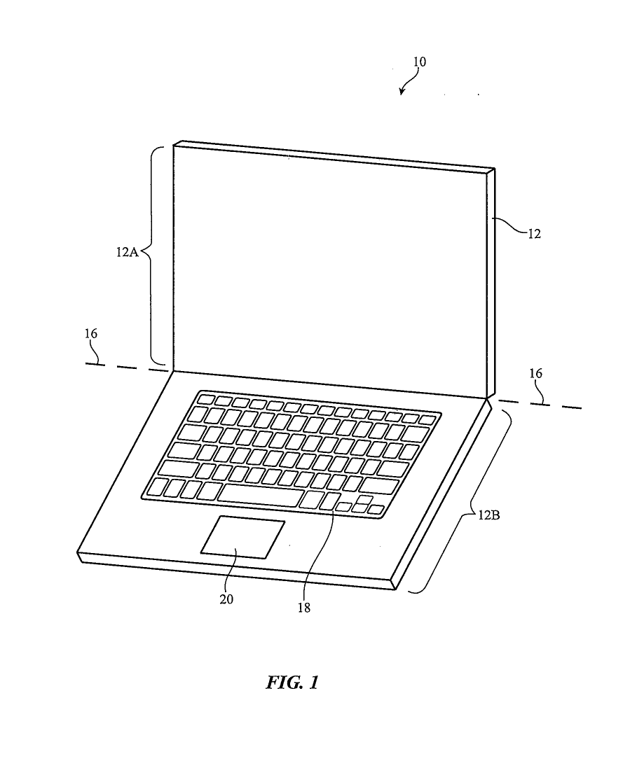

An illustrative electronic device of the type that may be provided with a display having white subpixels is shown in FIG. 1. Electronic device 10 may be a computer such as a computer that is integrated into a display such as a computer monitor, a laptop computer, a tablet computer, a somewhat smaller portable device such as a wrist-watch device, pendant device, or other wearable or miniature device, a cellular telephone, a media player, a tablet computer, a gaming device, a navigation device, a computer monitor, a television, or other electronic equipment.

As shown in FIG. 1, device 10 may include a display such as display 14. Display 14 may be a touch screen that incorporates capacitive touch electrodes or other touch sensor components or may be a display that is not touch-sensitive. Display 14 may include image pixels formed from light-emitting diodes (LEDs), organic light-emitting diodes (OLEDs), plasma cells, electrophoretic display elements, electrowetting display elements, liquid crystal display (LCD) components, or other suitable image pixel structures. Arrangements in which display 14 is a liquid crystal display are sometimes described herein as an example. This is, however, merely illustrative. Any suitable type of display technology may be used in forming display 14 if desired.

Device 10 may have a housing such as housing 12. Housing 12, which may sometimes be referred to as a case, may be formed of plastic, glass, ceramics, fiber composites, metal (e.g., stainless steel, aluminum, etc.), other suitable materials, or a combination of any two or more of these materials.

Housing 12 may be formed using a unibody configuration in which some or all of housing 12 is machined or molded as a single structure or may be formed using multiple structures (e.g., an internal frame structure, one or more structures that form exterior housing surfaces, etc.).

As shown in FIG. 1, housing 12 may have multiple parts. For example, housing 12 may have upper portion 12A and lower portion 12B. Upper portion 12A may be coupled to lower portion 12B using a hinge that allows portion 12A to rotate about rotational axis 16 relative to portion 12B. A keyboard such as keyboard 18 and a touch pad such as touch pad 20 may be mounted in housing portion 12B.

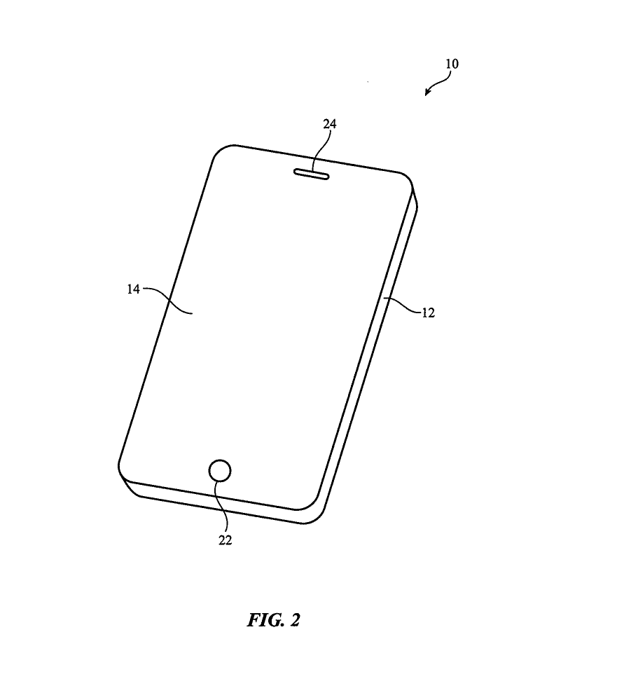

In the example of FIG. 2, device 10 has been implemented using a housing that is sufficiently small to fit within a user's hand (e.g., device 10 of FIG. 2 may be a handheld electronic device such as a cellular telephone). As show in FIG. 2, device 10 may include a display such as display 14 mounted on the front of housing 12. Display 14 may be substantially filled with active display pixels or may have an active portion and an inactive portion. Display 14 may have openings (e.g., openings in the inactive or active portions of display 14) such as an opening to accommodate button 22 and an opening to accommodate speaker port 24.

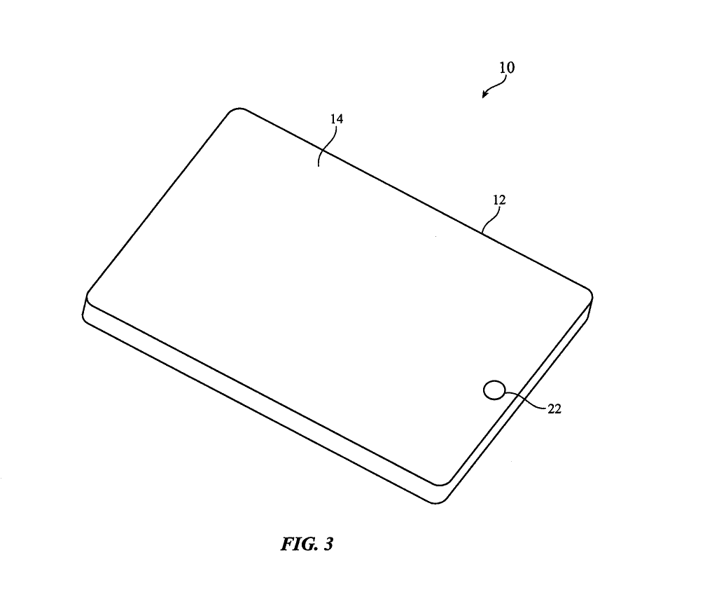

FIG. 3 is a perspective view of electronic device 10 in a configuration in which electronic device 10 has been implemented in the form of a tablet computer. As shown in FIG. 3, display 14 may be mounted on the upper (front) surface of housing 12. An opening may be formed in display 14 to accommodate button 22.

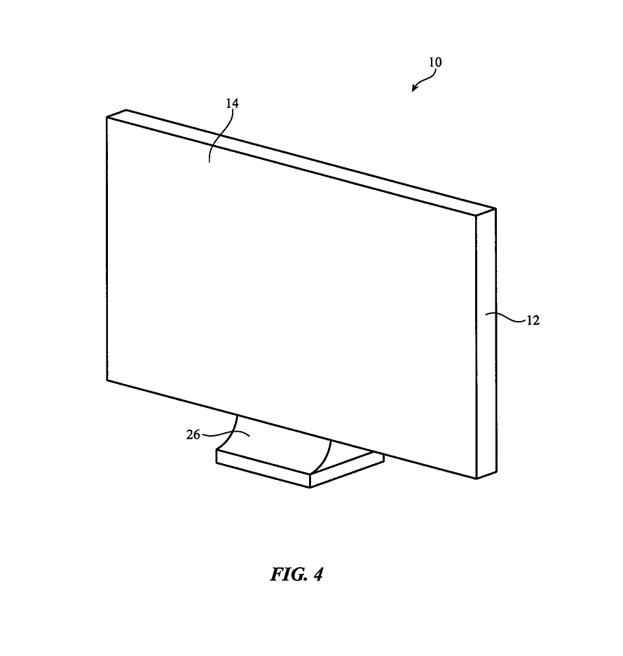

FIG. 4 is a perspective view of electronic device 10 in a configuration in which electronic device 10 has been implemented in the form of a computer integrated into a computer monitor. As shown in FIG. 4, display 14 may be mounted on a front surface of housing 12. Stand 26 may be used to support housing 12.

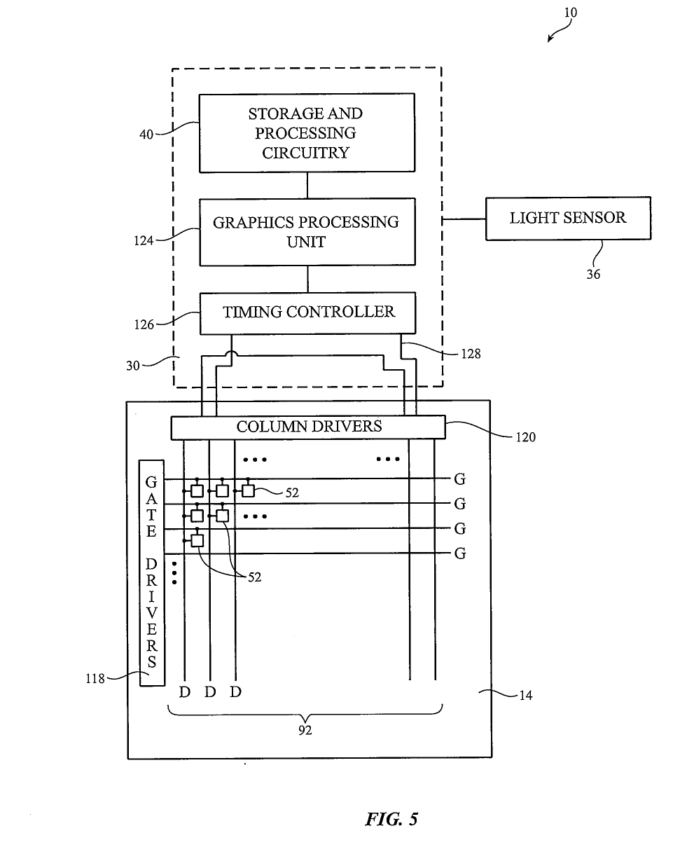

FIG. 5 is a diagram of device 10 showing illustrative circuitry that may be used in displaying images for a user of device 10 on pixel array 92 of display 14. As shown in FIG. 5, display 14 may have column driver circuitry 120 that drives data signals (analog voltages) onto the data lines D of array 92. Gate driver circuitry 118 drives gate line signals onto gate lines G of array 92. Using the data lines and gate lines, display pixels 52 may be configured to display images on display 14 for a user. Gate driver circuitry 118 may be implemented using thin-film transistor circuitry on a display substrate such as a glass or plastic display substrate or may be implemented using integrated circuits that are mounted on the display substrate or attached to the display substrate by a flexible printed circuit or other connecting layer. Column driver circuitry 120 may be implemented using one or more column driver integrated circuits that are mounted on the display substrate or using column driver circuits mounted on other substrates.

Device 10 may include storage and processing circuitry 122. Storage and processing circuitry 122 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 122 may be used in controlling the operation of device 10. The processing circuitry may be based on a processor such as a microprocessor and other suitable integrated circuits. With one suitable arrangement, storage and processing circuitry 122 may be used to run software on device 10, such as internet browsing applications, email applications, media playback applications, operating system functions, software for capturing and processing images, software implementing functions associated with gathering and processing sensor data, software that makes adjustments to display brightness and touch sensor functionality, etc.

During operation of device 10, storage and processing circuitry 122 may produce data that is to be displayed on display 14. This display data may be provided to display control circuitry such as timing controller integrated circuit 126 using graphics processing unit 124.

Timing controller 126 may provide digital display data to column driver circuitry 120 using paths 128. Column driver circuitry 120 may receive the digital display data from timing controller 126. Using digital-to-analog converter circuitry within column driver circuitry 120, column driver circuitry 120 may provide corresponding analog output signals on the data lines D running along the columns of display pixels 90 of array 92.

Storage and processing circuitry 122, graphics processing unit 124, and timing controller 126 may sometimes collectively be referred to herein as display control circuitry 30. Display control circuitry 30 may be used in controlling the operation of display 14. This may include, for example, converting input RGB values to output RGBW values and subsequently determining how to render the RGBW values onto the physical pixel structure.

As shown in FIG. 5, device 10 may include one or more sensors such as light sensor 36. Light sensor 36 may include one or more light meters, one or more color meters, one or more color temperature meters, and/or other types of light sensors. Light sensor 36 may be configured to gather color information, illuminance information, luminance information, and/or color temperature information from the surrounding scene. Light sensor 36 may supply readings such as color chromaticity coordinates (x,y), illuminance readings, luminance readings, and/or correlated color temperature (CCT) readings to display control circuitry 30.

Display control circuitry 30 may convert input RGB values to output RGBW values based at least partly on ambient lighting condition information provided by light sensor 36. For example, in bright ambient lighting conditions, display control circuitry 30 may use an RGB to RGBW conversion algorithm that maximizes outdoor readability. In less bright ambient lighting conditions, display control circuitry 30 may use an RGB to RGBW conversion algorithm that maximizes power efficiency.

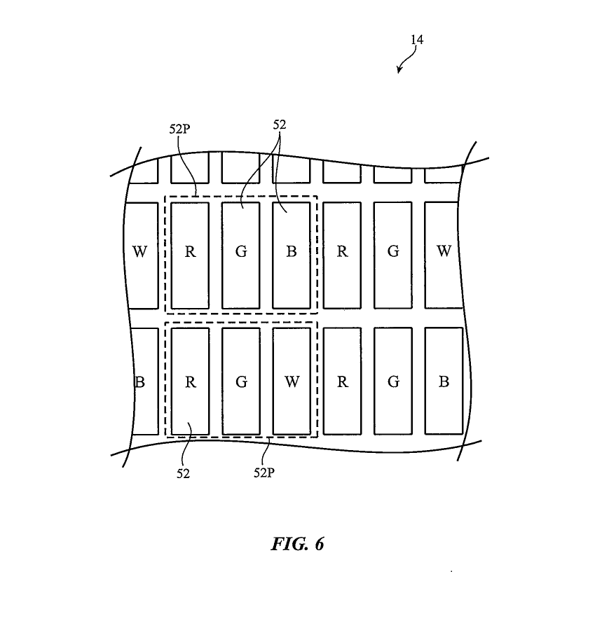

A portion of an illustrative array of display pixels that may be used in display 14 is shown in FIG. 6. As shown in FIG. 6, display 14 may have a pixel array with rows and columns of pixels such as display pixels 52P. Each display pixel 52P may include multiple subpixels 52. There may be tens, hundreds, or thousands of rows and columns of subpixels 52. Each subpixel 52 may, if desired, be a color subpixel such as a red (R) subpixel, a green (G) pixel, a blue (B) subpixel, a white (W) subpixel, or a subpixel of another color.

Colored subpixels such as red, green, and blue subpixels 52 may include a color filter element (e.g., a red, green, or blue color filter element) formed over a white pixel element (e.g., a liquid crystal pixel that transmits white light from a backlight unit or an organic light-emitting diode pixel that emits white light). White subpixels may be formed from an unfiltered white pixel element. Arrangements in which display 14 is a liquid crystal display having a color filter array formed over an array of display pixels that transmit white light from a backlight is sometimes described herein as an example.

As shown in FIG. 6, some pixels 52P include a red subpixel 52, a green subpixel 52 and a blue subpixel 52, whereas other pixels 52P include a red subpixel 52, a green subpixel 52, and a white subpixel 52. This type of pixel pattern is sometimes described as an RGB-RGW pixel cell pattern. If desired, subpixels 52 may all have the same aperture ratio or subpixels 52 may have different aperture ratios. For example, blue and white subpixels 52 may have a larger aperture ratio than red and green subpixels 52 to preserve a desired white point.

The pixel pattern of FIG. 6 is merely illustrative, however. Colored subpixels may be arranged in any suitable pattern. For example, each display pixel 52P may include a red subpixel, a green subpixel, a blue subpixel, and a white subpixel (sometimes referred to as an RGBW four strip pixel structure), display pixels 52P may alternate between including red and green subpixels only and blue and white subpixels only (sometimes referred to as a RG-BW pixel structure), or display pixels 52 may have any other suitable pixel pattern that includes white subpixels.

Display control circuitry 30 (FIG. 5) such as a display driver integrated circuit and, if desired, associated thin-film transistor circuitry formed on a display substrate layer may be used to produce signals such as data signals and gate line signals (e.g., on data lines and gate lines, respectively, in display 14) for operating pixels 52 (e.g., turning pixels 52 on and off, adjusting the intensity of pixels 52, etc.). During operation, display control circuitry 30 may control the values of the data signals and gate signals to control the light intensity associated with each of the display pixels and to thereby display images on display 14.

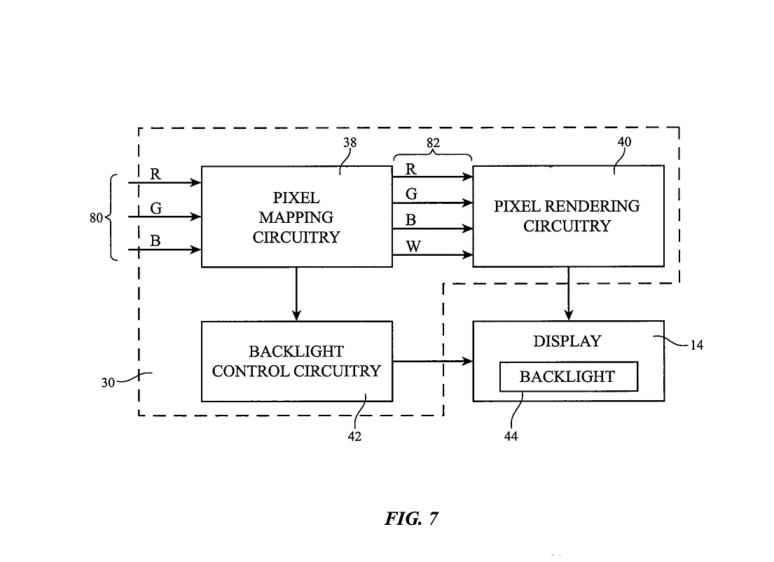

A schematic diagram of illustrative circuitry that may be used to display images on display 14 is shown in FIG. 7. As shown in FIG. 7, display control circuitry 30 may include pixel mapping circuitry 38, pixel rendering circuitry 40 and backlight control circuitry 42. Pixel mapping circuitry 38 may convert incoming RGB values 80 to output RGBW values 82 and may provide the RGBW values 82 to pixel rendering circuitry 40. Pixel rendering circuitry 40 may determine how to render the RGBW pixel values onto the physical pixel structure. Backlight control circuitry 42 may be used to adjust the brightness of backlight 44 of display 14. For example, backlight controller 42 may adjust the power provided to backlight 44 based on the brightness increase achieved through mapping RGB pixel values to RGBW pixel values.

Pixel mapping circuitry 38 may use the following formulas to map RGB input values 80 to RGB output values 82:

Ro=Ri*F−Wo

Go=Gi*F−Wo

Bo=Bi*F−Wo

Wo=min(Ri, Gi, Bi) (1)

where Ro, Go, Bo, and Wo correspond to RGBW output pixel values; Ri, Gi, and Bi correspond to RGB input pixel values;

and F corresponds to a brightness adjustment factor (sometimes referred to as a brightness gain value) that is applied to the RGB input values before subtracting the luminance portion to be contributed by the white subpixel. A larger brightness adjustment factor F corresponds to a greater luminance contribution from the white subpixel and therefore greater power efficiency. Brightness adjustment factor F may, for example, be a number ranging from 1 to 2.

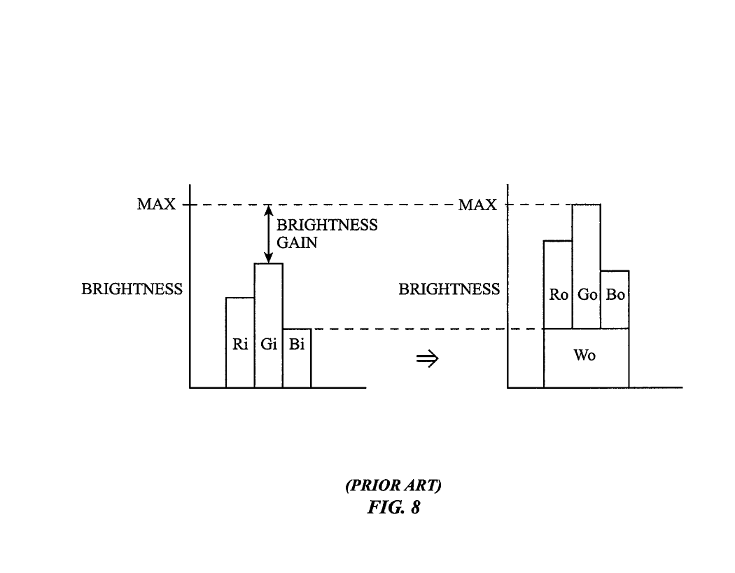

A typical method for converting RGB input pixel values to RGBW output pixel values is illustrated in FIG. 8. In this method, the white subpixel value Wo is defined as the minimum value of the RGB input values, and the brightness gain is defined on a per-pixel basis based on the minimum and maximum values of the RGB input values. This method avoids pixel clipping but can lead to brightness gain imbalances since different gain values can be applied to different sets of RGB input values.

To avoid brightness gain imbalances, the brightness gain adjustment factor F may be applied globally to all RGB input pixel values in a frame of display data. However, since the maximum brightness increase of each pixel varies based on its color, some pixels may experience clipping after mapping to RGBW. For example, applying a gain value of 2 to an RGB input value of (R=255, G=255, B=255) would be mapped to the unclipped RGBW output value of (R=255, G=255, B=255, W=255), whereas applying a gain value of 2 to an RGB input value of (R=255, G=0, B=0) would clip to an RGBW value of (R=255, G=0, B=0, W=0).

A typical solution to this issue is to impose a static threshold corresponding to the maximum percentage of pixels that can experience clipping after mapping from RGB to RGBW. The global brightness gain value is determined such that the percentage of pixels that are clipped after mapping to RGBW is kept under the threshold.

However, a single pixel clipping threshold may not be suitable for all types of images. For example, a certain percentage of pixels experiencing clipping in one image may not be noticeable to a user, whereas the same percentage of pixels experiencing clipping in another image (e.g., a website image or user interface image) may be noticeable and unsightly to a user.

To avoid noticeable amounts of pixel clipping while maximizing the luminance contribution from the white subpixel, pixel mapping circuitry 38 of FIG. 7 may dynamically determine a pixel clipping threshold on a per-frame basis based on the content in the frame of display data. For example, pixel mapping circuitry 38 may determine a global brightness adjustment factor F that maximizes the luminance contribution from the white subpixel while maintaining any color distortion that results from applying the brightness adjustment factor at or below a level that is just distinguishable to the human eye (sometimes referred to as a just-noticeable-difference or 1 JND). Because the JND threshold is determined based on the content of the image frame, this method ensures that the brightness adjustment factor F is maximized without compromising image quality.

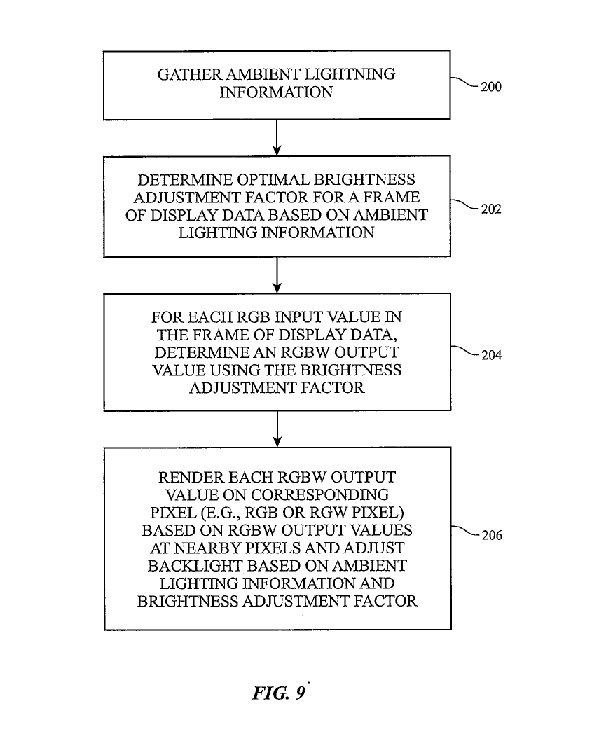

A flow chart of illustrative steps involved in displaying images on display 14 using the circuitry of FIG. 7 is shown in FIG. 9.

At step 200, display control circuitry 30 may gather ambient lighting information from a light sensor (e.g., light sensor 36 of FIG. 5).

At step 202, pixel mapping circuitry 38 may determine a brightness adjustment factor F for a frame of display data based on the ambient lighting information. For example, if the ambient light brightness is above a threshold (e.g., in an outdoor setting), pixel mapping circuitry 38 may use a first algorithm to determine the brightness adjustment factor F. If the ambient light brightness is below the threshold (e.g., in an indoor setting), pixel mapping circuitry 38 may use a second algorithm to determine the brightness adjustment factor F. The first algorithm may maximize the brightness adjustment factor F to improve outdoor readability. This may include increasing the brightness of the white subpixel even if some pixel clipping may occur. The second algorithm may determine a brightness adjustment factor F that maximizes power efficiency.

At step 204, pixel mapping circuitry 38 may determine an RGBW output pixel value for each RGB input pixel value in the frame of display data using the brightness adjustment factor F determined in step 202. This may include, for example, using the formulas shown in (1) to compute RGBW output pixel values for each RGB input pixel value in the frame of display data. In the alternative, the following formulas may be used to determine RGBW output values Ro, Go, Bo, and Wo for each RGB input value Ri, Gi, and Bi:

Ro=Ri*F−Wo

Go=Gi*F−Wo

Bo=Bi*F−Wo

Wo=max(Y max*F−1, Y min* F/P)

Y min=min(Ri, Gi, Bi)

Y max=max(Ri, Gi, Bi) (2)

where F is the brightness adjustment factor determined in step 202 and P is positive number such as 2 or ¾ (as examples). The formulas shown in (2) above may be used to evenly distribute white luminance to the red, green, blue, and white subpixels, which in turn helps to avoid the appearance of black “holes” in pixels where not enough luminance is contributed by a white subpixel or by red, green, and blue subpixels. For example, edges in an image may appear smoother when the formulas of (2) are used to evenly distribute the white luminance to the red, green, blue and white subpixels.

At step 206, pixel rendering circuitry 40 of FIG. 7 may receive RGBW pixel values for the frame of display data from pixel mapping circuitry 38 and may determine how to render the RGBW pixel values onto respective pixel structures. For example, if each display pixel 52P includes a red subpixel, a green subpixel, a blue subpixel, and a white subpixel, then pixel rendering circuitry 40 would provide Ro to the red subpixel, Go to the green subpixel, Bo to the blue subpixel, and Wo to the white subpixel.

If, on the other hand, each display pixel 52P does not include all four subpixels 52 (as in the example of FIG. 6), then pixel rendering circuitry 40 may render RGBW values onto display pixels 52P in one of two ways. In one suitable embodiment, pixel rendering circuitry 40 may route a pixel value to a subpixel 52 only if it is located at the intended destination for that pixel value. If the display pixel 52P at the intended destination for a blue pixel value does not include a blue subpixel, then the blue pixel value would not be routed to the display. Similarly, if the display pixel 52P at the intended destination for a white pixel value does not include a white subpixel, then the white pixel value would not be routed to the display.

In another suitable method, pixel rendering circuitry 40 may use neighboring subpixels to compensate for the missing subpixel in a display pixel. For example, if a display pixel 52P is intended to be blue but does not include a blue subpixel (e.g., the RGW pixel in an RGB-RGW pixel pattern of the type shown in FIG. 6), the blue subpixel in neighboring display pixels 52P may be turned on to compensate for the missing blue content. Illustrative formulas that may be used by pixel rendering circuitry 40 to render an RGBW value onto an RGB-RGW pixel structure at location (i,j) are as follows:

R_{i,j}=r_{i,j}

G_{i,j}=g_{i,j}

B_{i,j}=p₁*b_{i,j}+p₂*b_{i+,j}+p₃*b_{i,j+1}+p₄*b_{i+1,j+1}

W_{i,j}=q₁*w_{i,j}+q₂*w_{i+1,j}+q₃*w_{i,j+1}+1₄*w_{i+1,j+1} (3)

where r_{i,j}, g_{i,j}, and w_{i,j} are the RGBW pixel values output from pixel mapping circuitry 38 for a display pixel 52P at location (i,j); R_{i,j}, G_{i,j}, B_{i,j}, and W_{i,j} are the RGBW pixel values that pixel rendering circuitry 40 assigns to the physical RGB-RGW pixel structure at location (i,j); and p₁, p₂, p₃, p₄, q₁, q₂, q₃, and q₄ are weighting factors that may be chosen based on the desired smoothness (e.g., based on the desired direction of smoothness). Using neighboring subpixels to compensate for missing content in a display pixel (e.g., missing blue content or white content), may help smooth images on display 14. For example, a blue line intended to be one pixel wide can be displayed using blue subpixels in two neighboring columns of pixels, and will appear to be a smooth single-pixel-wide line to the human eye.

Step 206 may also include adjusting backlight 44 using backlight control circuitry 42 based on ambient lighting information gathered in step 200 and based on the brightness adjustment factor F determined in step 202. For example, if the ambient light brightness is above a threshold (e.g., in an outdoor setting), backlight control circuitry 42 may operate backlight 44 in normal power mode to improve readability. Even though backlight 44 is operated in a normal power mode, display brightness may be increased by taking advantage of the white subpixels in display 14 (e.g., by maximizing the brightness adjustment factor F). If the ambient light brightness is below the threshold (e.g., in an indoor setting), backlight control circuitry 42 may operate backlight 44 in a low power mode. Even though backlight 44 is operated in a low power mode, display brightness may be maintained (or increased, if desired) by taking advantage of the white subpixels in display 14 (e.g., by maximizing the brightness adjustment factor F).

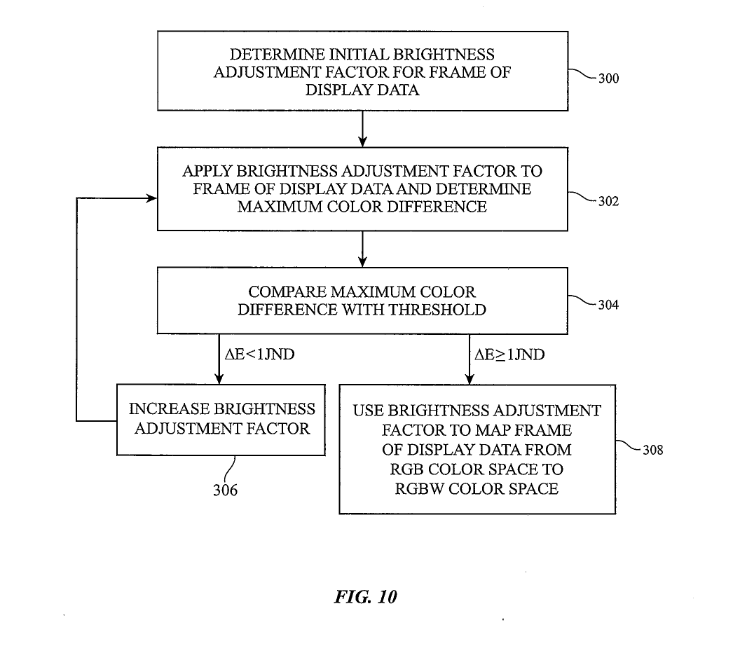

A flow chart of illustrative steps involved in determining brightness adjustment factor F (step 202 of FIG. 9) using an iterative method is shown in FIG. 10.

At step 300, pixel mapping circuitry 38 may determine an initial brightness adjustment factor for a frame of display data. The initial brightness adjustment factor may be set to a value that, when used in formulas (1) or (2) to map RGB pixel values to RGBW values, no pixel clipping occurs.

At step 302, pixel mapping circuitry 38 may use the brightness adjustment factor F to map each RGB input pixel value (Ri,Gi,Bi) in the frame of display data to a corresponding output RGBW pixel value (Ro,Go,Bo,Wo). Pixel mapping circuitry 38 may use formulas (1) or (2) to map the RGB input values to the RGBW output pixel values.

At step 304, pixel mapping circuitry 38 may determine the maximum color difference (sometimes referred to as delta E or ΔE) between the input frame of display data in RGB color space and the output frame of display data in RGBW color space (as determined in step 302). The maximum color difference may be determined using the CIE La*b* color space or may be determined using the spatial extension of CIE La*b* (sometimes referred to as S-CIE La*b*). The spatial extension of CIE La*b* uses a spatial filter to simulate the spatial frequency response of human vision.

The size of the spatial filter may be determined based on pixel size and the distance between a user's eyes and the display. Pixel mapping circuitry 38 may compare the maximum color difference with a threshold. For example, pixel mapping circuitry 38 may determine whether the maximum color difference ΔE exceeds 1 just-noticeable-difference (JND) level. A typical JND can be calculated in CIE La*b* space using JND=2.3(ΔL²+Δa*²+Δb*²) ^{0.5} or by using a ΔE₂₀₀₀ color difference equation.

If the maximum color difference is less than the threshold (e.g., if ΔE is less than 1 JND), then processing may proceed to step 306.

At step 306, pixel mapping circuitry 38 may increase the brightness adjustment factor F. Processing may then loop back to step 302 in which pixel mapping circuitry 38 uses the increased brightness adjustment factor to map each input RGB pixel value in the frame of display data to an output RGBW pixel value. Steps 302, 304, and 306 may be repeated, iteratively increasing the brightness adjustment factor with each cycle, until it is determined in step 304 that the maximum color difference reaches or exceeds the threshold (e.g., until ΔE is greater than or equal to 1 JND). When the threshold is reached or exceeded, processing may proceed to step 308.

At step 308, pixel mapping circuitry 38 may use the final brightness adjustment factor F to map each RGB input pixel value (Ri,Gi,Bi) in the frame of display data to a corresponding RGBW pixel value (Ro,Go,Bo,Wo). Pixel mapping circuitry 38 may use formulas (1) or (2) to map the RGB input values to the RGBW output pixel values. Pixel mapping circuitry 38 may then output the RGBW pixel values to pixel rendering circuitry 40 for rendering on display pixels 52P.

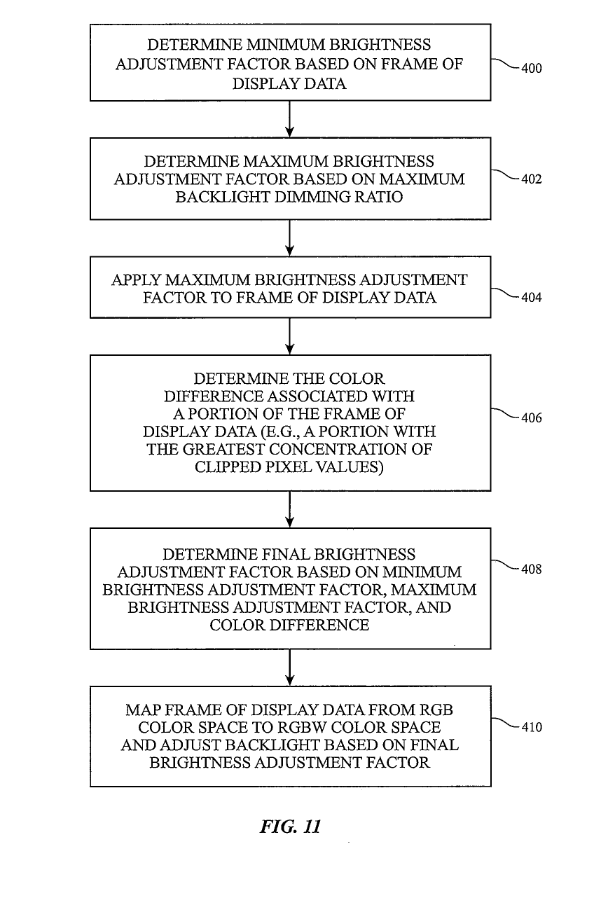

A flow chart of illustrative steps involved in determining brightness adjustment factor F (step 202 of FIG. 9) using an interpolation method is shown in FIG. 11.

At step 400, pixel mapping circuitry 38 may determine a minimum brightness adjustment factor for a frame of display data. The minimum brightness adjustment factor may be set to a value that, when used in formulas (1) or (2) to map RGB pixel values to RGBW values, no pixel clipping occurs (as an example).

At step 402, pixel mapping circuitry 38 may determine a maximum brightness adjustment factor for the frame of display data. If desired, the maximum brightness adjustment factor may be determined based on the maximum backlight dimming ratio. For example, if the maximum amount by which backlight brightness can be reduced is ½, then the maximum brightness adjustment factor may be equal to 2.

At step 404, pixel mapping circuitry 38 may use the maximum brightness adjustment factor to map each RGB input pixel value (Ri,Gi,Bi) in the frame of display data to a corresponding RGBW pixel value (Ro,Go,Bo,Wo). Pixel mapping circuitry 38 may use formulas (1) or (2) to map the RGB input values to the RGBW output pixel values.

At step 406, pixel mapping circuitry 38 may determine the maximum color difference (e.g., ΔE) between the input frame of display data in RGB color space and the output frame of display data in RGBW color space (as determined in step 404). The maximum color difference may be determined using the CIE La*b* color space or may be determined using the spatial extension of CIE La*b*.

If desired, pixel mapping circuitry 38 may use only a portion of the display data to determine the maximum color difference. For example, pixel mapping circuitry 38 may identify a region or block in the image that includes the greatest concentration of clipped pixels as a result of the brightness increase applied through mapping from RGB to RGBW. The color difference AE may be calculated based on this smaller region rather than using the entire frame of display data.

At step 408, pixel mapping circuitry 38 may determine a final brightness adjustment factor (e.g., using interpolation) based on the minimum brightness adjustment factor (determined in step 400), the maximum brightness adjustment factor (determined in step 402), and the maximum color difference (determined in step 406).

The final brightness adjustment factor F may, for example, be the xl coordinate of point (x1, y1) that lies on a line passing through point (x2, y2) and (x3, y3); where x2 is the minimum brightness adjustment factor, y2 is the color difference associated with the minimum brightness adjustment factor (e.g., zero), x3 is the maximum brightness adjustment factor, y3 is the maximum color difference associated with the maximum brightness adjustment factor (the AE calculated in step 406), and y1 is 1 JND (e.g., a ΔE of 2.3).

At step 410, pixel mapping circuitry 38 may use the final brightness adjustment factor F to map each RGB input pixel value (Ri,Gi,Bi) in the frame of display data to a corresponding RGBW pixel value (Ro,Go,Bo,Wo). Pixel mapping circuitry 38 may use formulas (1) or (2) to map the RGB input values to the RGBW output pixel values. Pixel mapping circuitry 38 may then output the RGBW pixel values to pixel rendering circuitry 40 for rendering on display pixels 52P.

Step 410 may also include adjusting the backlight based on the final brightness adjustment factor. For example, backlight control circuitry 42 may operate backlight 44 in a low power mode by reducing backlight brightness by an amount based on the brightness increase achieved through mapping to RGBW. Even though the brightness of backlight 44 is reduced, the overall display brightness may be maintained (or increased, if desired) by taking advantage of the white subpixels in display 14 (e.g., using the brightness adjustment factor F).

The foregoing is merely illustrative of the principles of this invention and various modifications can be made by those skilled in the art without departing from the scope and spirit of the invention. The foregoing embodiments may be implemented individually or in any combination.

What is claimed is:

1. A method for displaying a frame of display data on an array of display pixels in a display, comprising:
with a light sensor, gathering ambient lighting information;
with pixel mapping circuitry, determining a brightness adjustment factor for the frame of display data based on the ambient lighting information; and
with the pixel mapping circuitry, mapping input red-green-blue pixel values in the frame of display data to output red-green-blue-white pixel values using the brightness adjustment factor.

2. The method defined in claim 1 wherein mapping the input red-green-blue pixel values in the frame of display data to the output red-green-blue-white pixel values comprises applying the brightness adjustment factor to each red-green-blue pixel value in the frame of display data.

3. The method defined in claim 2 wherein each output red-green-blue-white pixel value includes a white subpixel value and wherein mapping the input red-green-blue pixel values in the frame of display data to the output red-green-blue-white pixel values comprises determining the white subpixel value based on the brightness adjustment factor.

4. The method defined in claim 1 wherein determining the brightness adjustment factor comprises:
with the pixel mapping circuitry, applying a minimum brightness adjustment factor to the input red-green-blue pixel values in the frame of display data; and
determining a maximum color difference associated with applying the minimum brightness adjustment factor to the input red-green-blue pixel values.

5. The method defined in claim 4 wherein determining the brightness adjustment factor further comprises:
comparing the maximum color difference with a threshold.

6. The method defined in claim 5 wherein determining the brightness adjustment factor further comprises:
in response to determining that the maximum color difference is less than the threshold, increasing the minimum brightness adjustment factor.

7. The method defined in claim 5 wherein the threshold is a just-noticeable-difference (JND) threshold.

8. The method defined in claim 1 wherein determining the brightness adjustment factor comprises:
with the pixel mapping circuitry, applying a maximum brightness adjustment factor to the input red-green-blue pixel values in the frame of display data; and
determining a maximum color difference associated with applying the maximum brightness adjustment factor to the input red-green-blue pixel values.

9. The method defined in claim 8 wherein determining the brightness adjustment factor further comprises:
with the pixel mapping circuitry, determining a minimum brightness adjustment factor; and
determining the brightness adjustment factor based on the minimum brightness adjustment factor, the maximum brightness adjustment factor, and the maximum color difference.

10. The method defined in claim 1 wherein the display comprises a backlight, the method further comprising:
with backlight control circuitry, adjusting a backlight power level associated with the backlight based on the ambient lighting information and the brightness adjustment factor.

11. A method for displaying a frame of display data on an array of display pixels in a display, comprising:
with pixel rendering circuitry, receiving a first subpixel value for a first subpixel at a first location on the display; and
with the pixel rendering circuitry, determining a second subpixel value for a second subpixel at a second location on the display based at least partly on the first subpixel value.

12. The method defined in claim 11 wherein the display pixels include red-green-blue display pixels each having a red subpixel, a green subpixel, and a blue subpixel and red-green-white display pixels each having a red subpixel, a green subpixel, and a white subpixel, and wherein the first and second subpixels are blue subpixels in red-green-blue display pixels.

13. The method defined in claim 12 wherein determining the second subpixel value for the second subpixel comprises compensating for a missing blue subpixel in one of the red-green-white display pixels.

14. The method defined in claim 11 wherein determining the second subpixel value comprises determining the second subpixel value based on a weighted average of the first subpixel value and at least a third subpixel value for a third subpixel at a third location on the display.

15. A method for displaying a frame of display data on an array of display pixels in a display, comprising:
with pixel mapping circuitry, determining a brightness adjustment factor for the frame of display data; and
with the pixel mapping circuitry, mapping input red-green-blue pixel values in the frame of display data to output red-green-blue-white pixel values using the brightness adjustment factor, wherein each output red-green-blue-white pixel value includes a white subpixel value and wherein mapping the input red-green-blue pixel values in the frame of display data to the output red-green-blue-white pixel values comprises determining the white subpixel value based at least partly on the brightness adjustment factor.

16. The method defined in claim 15 wherein mapping the input red-green-blue pixel values in the frame of display data to the output red-green-blue-white pixel values comprises applying the brightness adjustment factor to each red-green-blue pixel value in the frame of display data.

17. The method defined in claim 15 further comprising:
with a light sensor, gathering ambient lighting information, wherein determining the brightness adjustment factor comprises determining the brightness adjustment factor based on the ambient lighting information.

18. The method defined in claim 17 wherein the display comprises a backlight, the method further comprising:
with backlight control circuitry, adjusting a backlight power level associated with the backlight based on the ambient lighting information and the brightness adjustment factor.

19. The method defined in claim 15 wherein determining the brightness adjustment factor comprises:
with the pixel mapping circuitry, applying the brightness adjustment factor to the input red-green-blue pixel values in the frame of display data; and
determining a maximum color difference associated with applying the brightness adjustment factor to the input red-green-blue pixel values.

20. The method defined in claim 19 wherein determining the brightness adjustment factor further comprises:
comparing the maximum color difference with a threshold, wherein the threshold corresponds to a just-noticeable-difference (JND) threshold.
